(19) United States
(12) Patent Application Publication
(10) Pub. No.: US 2020/0193158 A1
(43) Pub. Date: Jun. 18, 2020

(54) SYSTEM AND METHOD FOR PLANT SENSING USING AERIAL RGB IMAGERY

(71) Applicant: Purdue Research Foundation, West Lafayette, IN (US)

(72) Inventors: Edward John Delp, West Lafayette, IN (US); Ayman F. Habib, West Lafayette, IN (US); Fangning He, West Lafayette, IN (US); Christopher Boomsma, West Lafayette, IN (US); Javier Ribera, West Lafayette, IN (US); Yuhao Chen, West Lafayette, IN (US)

(21) Appl. No.: 16/103,909

(22) Filed: Aug. 14, 2018

Related U.S. Application Data
(60) Provisional application No. 62/545,461, filed on Aug. 14, 2017.

(51) Int. Cl. G06K 9/00; B64C 39/02; G01C 11/02; G06T 3/40

(52) U.S. Cl. CPC G06K 9/00657; B64C 39/024; G01C 11/02; B64C 2201/127; G06K 2009/00644; B64C 2201/123; G06T 3/4038

(57) ABSTRACT

A system and method to estimate traits of plants from RBG cameras on board an unmanned aerial vehicle (UAV). The position and orientation of the imagery together with the coordinates of sparse points along the area of interest are derived through a triangulation method. A rectified orthophoto mosaic is then generated from the imagery. The number of leaves is estimated and a model-based method is used to analyze the leaf morphology for leaf segmentation.

### CROSS-REFERENCE TO RELATED APPLICATIONS

The present patent application is related to and claims the priority benefit of U.S. Provisional Patent Application Ser. No. 62/545,461, filed Aug. 14, 2017, the contents of which is hereby incorporated by reference in its entirety into the present disclosure.

### GOVERNMENT RIGHTS

This invention was made with government support under grant No. DE-AR0000593, awarded by the Department of Energy. The United States government has certain rights in the invention.

### TECHNICAL FIELD

The present disclosure generally relates to aerial imaging systems, and in particular to a system and method for plant sensing using aerial RGB imagery.

### BACKGROUND

This section introduces aspects that may help facilitate a better understanding of the disclosure. Accordingly, these statements are to be read in this light and are not to be understood as admissions about what is or is not prior art.

Biological In many agricultural applications one wants to characterize physical properties of plants and use the measurements to predict, for example, biomass and environmental influence. This process is known as phenotyping. Obtaining high quality phenotypic information is of crucial importance for plant breeders in order to study a crop's performance. Some phenotypic traits such as leaf area have been shown to be correlated with above-ground biomass. Collecting phenotypic data is often done manually and in a destructive manner. Therefore, improvements are needed in the field.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a diagram of a co-planarity matrix for stereo images according to one embodiment.

FIG. 2 is a diagram of stereo images from a UAV platform equipped with a nadir-looking camera while moving at a constant flying height according to one embodiment.

FIG. 3 is a diagram showing a process for leaf global bundle adjustment according to one embodiment.

FIG. 4A shows a section of an orthorectified mosaic at an altitude of 15 m according to one embodiment.

FIG. 4B shows the result of a leaf segmentation process from the mosaic of FIG. 4A according to one embodiment.

FIG. 5A is a digital image representation of a leaf according to one embodiment.

FIG. 5B is a digital image of a leaf slice connecting two pixels according to one embodiment.

FIG. 5C is a digital image of a leaf wherein G_{A} and G_{B} are gradient angles of pixels A and B according to one embodiment.

FIG. 5D is a digital image of a leaf wherein θ_{AB} and θ_{CD} are the angles the of slices S_{AB} and S_{CD} according to one embodiment.

FIG. 6A is a digital image of a single leaf with a discontinuity that may be due to a leaf crossing according to one embodiment.

FIG. 6B is a digital image of two leaf segments L₁ and L₂ with almost parallel facing slices S_{AB} and S_{EF} according to one embodiment.

FIG. 6C is a digital image of a two leaf segments searched in the direction of θ_{AB} until the slice S_{EF} is found according to one embodiment.

FIG. 7 is an image of a single sorghum plant.

FIG. 8 is an image of vertical and horizontal alignments of plants in the field when viewed vertically.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

Current UAV-based mapping is usually executed according to a mission plan while relying on a consumer-grade navigation sensor within the platform's autopilot. Therefore, prior information, which describes the trajectory of the platform including the involved cameras, can be utilized to facilitate ROP recovery for stereo-images. We assume that such prior information can be either derived from a specific flight configuration (e.g., a UAV platform moving at a constant flying height while operating a nadir-looking camera) or established by a low-cost Micro-Electro-Mechanical-System (MEMS) integrated with a GPS unit onboard the UAV.

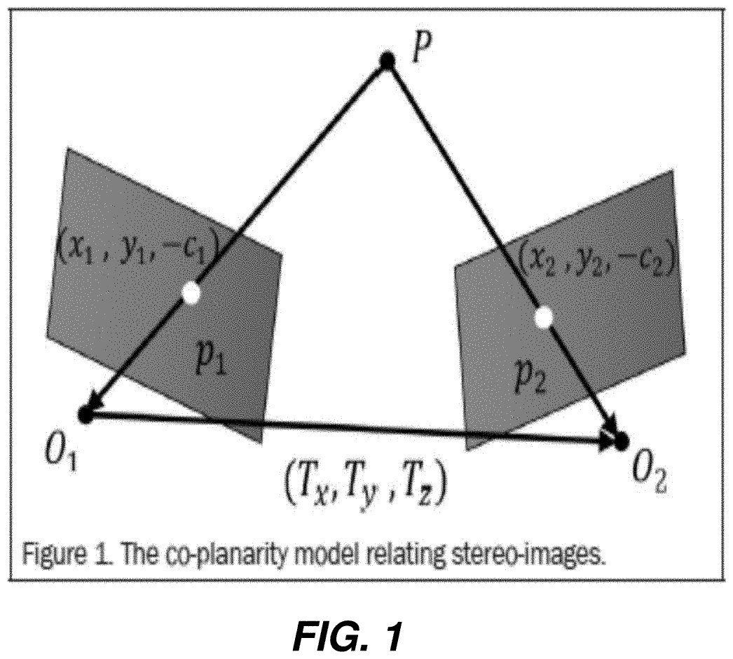

The Essential matrix E describes the epipolar geometry relating two corresponding points in a stereo-pair. The Essential matrix is based on the co-planarity constraint, which is depicted in FIG. 1. The co-planarity constraint mathematically describes the fact that an object point P, the corresponding image points, and the two perspective centers O₁ and O₂ of a stereo-pair must lie on the same plane (Equation 1).

p₁^{T}·(\vec{T}×R_{pz})=0 (1)

In this equation, p₁ and p₂ are two corresponding points, where p=(x, y, −c)^{T} represents the image coordinates corrected for the principal point offset and camera-specific distortions. In t, we consider the case that the stereo-images are acquired by two different cameras. The rotation matrix R, which is defined by three rotation angles ω, ϕ, and κ, describes the relative rotation relating overlapping images. T̅ is the translation vector describing the baseline between the stereo-images, and it can be defined by three translation components (Tₓ, T_{y}, T_{z}). The cross product in Equation 1 can be simplified using the skew-symmetric matrix \vec{T} in Equation 2. More specifically, the 3-by-3 matrix \vec{T} simplifies the cross product of two vectors to a matrix-vector multiplication. Using Equation 2, one can derive the expression for the Essential matrix as shown in Equation 3:

$$\begin{matrix}{p}_{1}^{T} \hat{T} {Rp}_{2} = 0 where & ( 2 ) \\ \hat{T} = [ \begin{matrix}0 & - Tz & Ty \\ Tz & 0 & - Tx \\ - Ty & Tx & 0\end{matrix} ] \\ E = [ \begin{matrix}0 & - Tz & Ty \\ Tz & 0 & - Tx \\ - Ty & Tx & 0\end{matrix} ] \\ R = [ \begin{matrix}{e}_{11} & {e}_{12} & {e}_{13} \\ {e}_{21} & {e}_{22} & {e}_{23} \\ {e}_{31} & {e}_{32} & {e}_{33}\end{matrix} ] & ( 3 )\end{matrix}$$

The nine elements of the Essential matrix are defined by the five elements fo the ROPs (three rotation angles and two translation components). Therefore, there must be four additional constraints that can be imposed on the nine elements of the Essential matrix E. Such constraints are explained as follows:

The Essential matrix has rank two. Therefore, its determinant has to be zero as shown in Equation 4, which leads to what is known as the cubic constraint on the nine unknown parameters of the Essential matrix.

det(E)=0 (4)

The Essential matrix has two equal non-zero singular values, which leads to the trace constraint as represented by Equation 5. Given the rank of, two independent equations on the nine unknown parameters can be deduced from the equality in Equation 5.

EE^{T}E−½ trace(EE^{T})E=0 (5)

The nine elements of the Essential matrix can be only determined up to a scale, which provides the fourth constraint.

Considering these four constraints, one can conclude that a minimum of five-point-correspondence is sufficient to estimate the nine unknown parameters of the Essential matrix. Using five point correspondences, a system of five linear equations of the form in Equation 6 can be established. An efficient solution of the Essential matrix using five feature correspondences, while considering the above constraints is provided, and the Essential matrix can then be used to derive the rotation matrix R and the translation vector \vec{T} relating the stero images. Possible solution for R and \vec{T} from a given Essential matrix are then given by:

x₁x₂e₁₁+x₁y₂e₁₂−x₁c₂e₁₃+y₁x₂e₂₁+y₁y₂e₂₂−y₁c₂e₂₃−c₁x₂e₃₁−c₁y₂e₃₂+c₁c₂e₂₃=0 (6)

Derivation of the Two-Point Approach

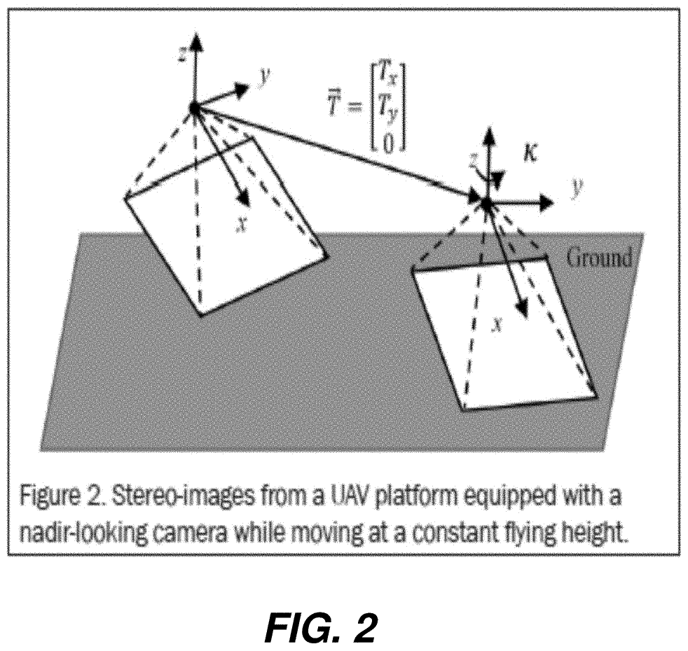

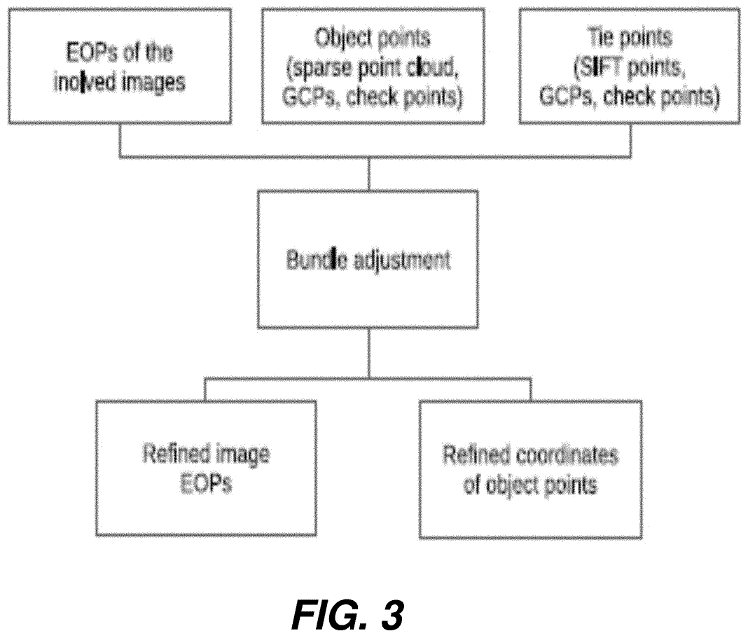

This approach according to one embodiment is based on acquired imagery from a nadir-looking camera onboard a UAV platform moving at a constant flying height. Within the robotics research community, this flight configuration is known as “planar motion,” where the platform's motion is constrained to a horizontal plane, and the rotation of the image plane is constrained along an axis orthogonal to the horizontal plane (i.e., with a reference direction that coincides with the normal to the plane of motion). The UAV-based planar motion leads to two geometric constraints that can be used to reduce and simplify the elements of the Essential matrix. As can be seen in FIG. 2, the geometric constraints lead to the following:

For a nadir-looking camera, the rotation angles ω and ϕ are assumed to be zero. Therefore, the relative rotation of the camera between the images of a stereo-pair is constrained to the rotation angle κ (i.e., heading). For a planar motion along the horizontal plane, the T_{Z} translation component is assumed to be zero.

Therefore, for a planar motion, the rotation matrix R and translation vector \vec{T} relating the stereo-images can be ex-pressed according to Equation 7, where x is the rotation angle, and Tₓ and T_{y} are the translation components describing the horizontal planar motion of the UAV platform. The expressions for R and \vec{T} can be substituted into Equation 3. This substitution will lead to the simplified Essential matrix in Equation 8, where L₁, L₂, L₃, and L₄ are used to denote the four unknown parameters of the Essential matrix E. As can be seen in Equation 8, L₁, L₂, L₃, and L₄ are derived from three independent parameters (Tₓ, T_{y}, and κ). Therefore, there should be one constraint relating the four elements of the Essential matrix. A closer inspection of the relationships between (L₁, L₂, L₃, L₄) and (Tₓ, T_{y}, and κ), one can introduce the constraint in Equation 9.

$$\begin{matrix} R = [ \begin{matrix}cos κ & - sin κ & 0 \\ sin κ & cos κ & 0 \\ 0 & 0 & 1\end{matrix} ] and T = [ \begin{matrix}{T}_{x} \\ {T}_{y} \\ 0\end{matrix} ] & ( 7 ) \\ \begin{matrix} E = [ \begin{matrix}0 & 0 & Ty \\ 0 & 0 & - Tx \\ - Ty & Tx & 0\end{matrix} ] [ \begin{matrix}cos κ & - sin κ & 0 \\ sin κ & cos κ & 0 \\ 0 & 0 & 1\end{matrix} ] \\ = [ \begin{matrix}0 & 0 & {T}_{y} \\ 0 & 0 & - {T}_{x} \\ - {T}_{y} cos κ + {T}_{z} sin κ & {T}_{y} sin κ + {T}_{x} cos κ & 0\end{matrix} ] \\ = [ \begin{matrix}0 & 0 & {L}_{1} \\ 0 & 0 & {L}_{2} \\ {L}_{3} & {L}_{4} & 0\end{matrix} ]\end{matrix} & ( 8 ) \\ L \text{?} + L \text{?} - L \text{?} - L \text{?} = 0. \\ \text{?} \text{indicates text missing or illegible when filed} & ( 9 )\end{matrix}$$

Given the simplified form for the Essential matrix that describes the relationship between conjugate points in stereo-images captured under horizontal planar motion constraints, we will focus on establishing the closed-form solution of the proposed two-point approach. Using the simplified Essential matrix, one can expand the relationship between the image coordinates of conjugate points to the form in Equation 10, where the image coordinates of the conjugate points p₁ and p₂ are represented by (x₁, y₁, −c₁) and (x₂, y₂, −c₂) after correcting for the principal point offsets and camera-specific distortions.

$${p}_{1}^{T} [ \begin{matrix}0 & 0 & {L}_{1} \\ 0 & 0 & {L}_{2} \\ {L}_{3} & {L}_{4} & 0\end{matrix} ] {p}_{2} = - x \text{?} c \text{?} L \text{?} - y \text{?} c L - x c L - y c L = 0 \\ \text{?} \text{indicates text missing or illegible when filed} \qquad ( 10 )$$

At this stage, the ROP recovery should be concerned with coming up with an estimate of the four parameters (L₁, L₂, L₃, L₄) while observing the inherent constraint among these parameters, which is represented by Equation 9, and the fact that these parameters can be only determined up to an arbitrary scale. Therefore, two conjugate point pairs should be sufficient for deriving the simplified Essential matrix. The presently disclosed closed-form solution for deriving the elements of the Essential matrix estimation starting from Equation 10 can be carried out as follows:

Given two conjugate point pairs, two linear equations, which can be represented using the matrix form in Equation 11, can be established:

$$[ \begin{matrix}- {x}_{1}^{1} {c}_{2} & - {y}_{1}^{1} {c}_{2} & - {x}_{2}^{1} {c}_{1} & - {y}_{2}^{1} {c}_{1} \\ - {x}_{1}^{2} {c}_{2} & - {y}_{1}^{2} {c}_{2} & - {x}_{2}^{2} {c}_{1} & - {y}_{2}^{2} {c}_{1}\end{matrix} ] [ \begin{matrix}{L}_{1} \\ {L}_{2} \\ {L}_{3} \\ {L}_{4}\end{matrix} ] = {A}_{2 \times 4} {L}_{4 \times 1} = 0 \qquad ( 11 )$$

Where (x₁¹, y₁¹, −c₁) and (x₂¹, y₂¹, −c₂) are the image coordinates for the first conjugate point pair, and (x₁², y₁², −c₁) and (x₂², y₂², −c₂) are the image coordinates for the second conjugate point pair.

As can be seen in Equation 11, the L_{4×1} vector belongs to the null space of the A_{2×4} and is comprised of the image coordinates of available conjugate point pairs. Therefore, the L₄₌₁ vector can be derived through a linear combination of the basis vectors \tilde{X} and \tilde{Y} spanning the right null-space of the matrix A_{2×4}. Assuming that the basis vectors \tilde{X}, and \tilde{Y} are presented by the elements in Equation 12, L₁, L₂, L₃, L₄ can be derived through the linear combination in Equation 13, where α and b are two arbitrary scale factors. Since the Essential matrix is determined only up to an arbitrary scale, one can choose a value of 1 for the scale factor b. Thus, the Essential matrix can be expressed by the form in Equation 14 using the basis vectors spanning the right null space of the A_{2×4} matrix.

Using the expressions for L₁, L₂, L₃, L₄ in Equation 13 and the inherent constraint in Equation 9, one can derive the second order polynomial in the unknown scale factor in Equation 15. The second order polynomial in Equation 15 provides up to two estimates for the scale factor α. Thus, two Essential matrices might be derived. For a given Essential matrix, R and T can be recovered through either the introduced singular value decomposition (SVD) approach or the closed-form solution. A total of four possible solutions of the rotation matrix R and translation vector \vec{T} can be recovered from a single Essential matrix. Therefore, up to eight solutions for R and \vec{T} can be derived from this approach. In order to identify the valid Essential matrix among the available solutions, two additional constraints can be utilized as follows:

The light rays connecting a derived object point and perspective centers should be on the same side of the baseline. The derived object points should be below the camera stations.

$$\begin{matrix} \tilde{X} = [ {\tilde{X}}_{1} , {\tilde{X}}_{2} , {\tilde{X}}_{3} , {\tilde{X}}_{4} ] \text{?} and \tilde{Y} = {[ {\tilde{Y}}_{1} , {\tilde{Y}}_{2} , {\tilde{Y}}_{3} , {\tilde{Y}}_{4} ]}^{T} & ( 12 ) \\ [ \begin{matrix}{L}_{1} \\ {L}_{2} \\ {L}_{3} \\ {L}_{4}\end{matrix} ] = a [ \begin{matrix}{\tilde{X}}_{1} \\ {\tilde{X}}_{2} \\ {\tilde{X}}_{3} \\ {\tilde{X}}_{4}\end{matrix} ] + b [ \begin{matrix}{\tilde{Y}}_{1} \\ {\tilde{Y}}_{2} \\ {\tilde{Y}}_{3} \\ {\tilde{Y}}_{4}\end{matrix} ] & ( 13 ) \\ E = [ \begin{matrix}0 & 0 & {L}_{1} \\ 0 & 0 & {L}_{2} \\ {L}_{3} & {L}_{4} & 0\end{matrix} ] = [ \begin{matrix}0 & 0 & a {\tilde{X}}_{1} + {\tilde{Y}}_{1} \\ 0 & 0 & a {\tilde{X}}_{2} + {\tilde{Y}}_{2} \\ a {\tilde{X}}_{3} + {\tilde{Y}}_{3} & a {\tilde{X}}_{4} + {\tilde{Y}}_{4} & 0\end{matrix} ] & ( 14 ) \\ ( {\tilde{X}}_{1}^{2} + {\tilde{X}}_{2}^{2} - {\tilde{X}}_{3}^{2} - {\tilde{X}}_{4}^{2} ) {a}^{2} + 2 ( - {\tilde{X}}_{1} {\tilde{Y}}_{1} - {\tilde{X}}_{2} {\tilde{Y}}_{2} + {\tilde{X}}_{3} {\tilde{Y}}_{3} + {\tilde{X}}_{4} {\tilde{Y}}_{4} ) a + ( {\tilde{Y}}_{1}^{2} + {\tilde{Y}}_{2}^{2} - {\tilde{Y}}_{3}^{2} - {\tilde{Y}}_{4}^{2} ) = 0 \\ \text{?} \text{indicates text missing or illegible when filed} & ( 15 )\end{matrix}$$

The above two-point approach assumes that the involved images are acquired from a nadir-looking camera onboard a UAV platform moving at a constant flying height. Therefore, the ω and ϕ rotation angles and the T_{z} translation component are assumed to be zero. Such prior flight information leads to the fact that a minimum of two conjugate point pairs can be used to derive the Essential matrix matrix relating a stereo pair through a closed form.

The above two-point approach can be integrated within a RANSAC framework for outlier detection and removal. More specifically, a random sample comprised of two conjugate point pairs is first drawn from potential matches and used to derive the Essential matrix E according to the procedure proposed in the previous section. To derive other matches that are compatible with such estimate of the Essential matrix (i.e., derive the corresponding inliers), the Sampson distance (Hartley and Zisserman, 2003), which is the first order approximation of the normal distances between a given conjugate point pair and the respective corresponding epipolar lines, is evaluated for the remaining potential matches. Such a sampling-and-testing procedure is repeated until a required number of trials/draws is achieved. The required number of trials, which is based on an assumed percentage of inliers, is derived according to a probabilistic basis to ensure that at least one correct draw has been executed as seen in Equation 16. Finally, the random sample with the highest number of inliers is selected and used for ROP estimation. In order to evaluate the computational efficiency of the proposed two-point approach when coupled with RANSAC for outlier removal in contrast to three, five, and eight point algorithms, the required number of trials N is presented in Table 1 (where ε is assumed to be 0.5 and the probability of having at least a single two correct conjugate point pairs within these trials is set to 0.99). As can be seen in Table 1, the required number of RANSAC trials is significantly reduced by using fewer number of conjugate point pairs. Therefore, the proposed two-point approach with a built-in RANSAC outlier detection/removal process is advantageous when compared with other approaches that require larger number of conjugate point pairs.

$$N = \frac{log ( 1 - p )}{log ( 1 - ( 1 - \text{?} ) \text{?} )} \\ \text{?} \text{indicates text missing or illegible when filed} \qquad ( 16 )$$

where s is the minimum number of required conjugate point pairs for rop estimation; ε is the probability of choosing an incorrect conjugate point pair, which is equivalent to the ratio between the assumed number of incorrect conjugate point pairs and the total number of potential conjugate point pairs; (1−e)³ is the probability of having correct conjugate point pairs in a single draw, and p in the probability of having at least a single sample comprised of correct conjugate point pairs.

TABLE 1
NUMBER OF RANSAC TRIALS FOR DIFFERENT
SAMPLE SIZES OF CONJUGATE POINT PAIRS

| | Number of required conjugate point pairs (s) | | | |
|---|---|---|---|---|
| | 2 | 3 | 5 | 8 |
| Number of Trials (N) | 16 | 35 | 145 | 1,177 |

Leaf Counting:

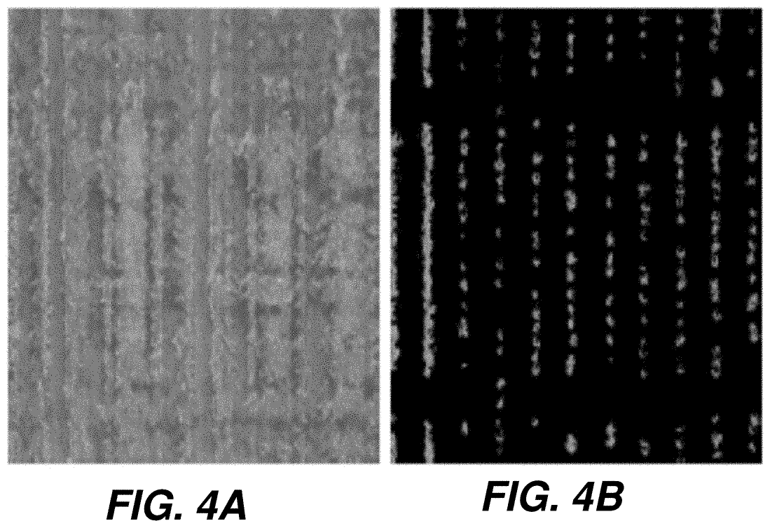

In one embodiment, a method for leaf counting using aerial images of a planted field is provided. First, the uncorrected image or orthomosaic is converted from RGB to HSV color space. From the image in the HSV color space, a segmentation mask Y is generated. Each pixel Yₘ in this mask is obtained as:

$${Y}_{m} = \{ \begin{matrix}1 & if {τ}_{1} \leq {H}_{m} \leq {τ}_{2} and ( {τ}_{3} \leq {S}_{m} or {τ}_{4} \leq {V}_{m} ) \\ 0 & otherwise\end{matrix} \qquad ( 4 )$$

Where Hm, Sm, and Vm are the hue, saturation, and the value of the pixel m. The thresholds τ1, τ2, τ3, and τ4 are determined experimentally. τ1 and τ2 select the characteristic green color of the leaves. τ3 and τ4 prevent misclassifying some soil pixels as leaves. Then, the number of pixels classified as sorghum leaves is determined as

$$α = {\sum }_{m = 0}^{M - 1} {Y}_{m} \qquad ( 5 )$$

where M is the number of pixels in the image. This pixel-wise segmentation makes use of the strong color difference between the sorghum leaves, which are generally green or yellow, and the soil and panicles, which are usually brown. An example of the segmentation result is shown in FIG. 4A shows a section of an orthorectified mosaic at an altitude of 15 m. FIG. 4B show the corresponding segmentation result. Now, we want to estimate the number of leaves, denoted as λ, from α. In order to do this, we assume that number of leaves and the number segmented pixels are linearly related as λ=α. This assumes that all leaves have approximately the same area. The number of pixels per leaf is ρ.

In order to calibrate ρ, a small region of the image is selected. The number of leaves in this region is manually counted and denoted as λ₀. The number of pixels classified as sorghum is denoted as α₀. Finally, ρ is estimated by ρ=α₀/λ₀, and the final leaf count can be obtained as λ=α/ρ. We experimentally determined that the relationship between the number of leaves and the number of sorghum pixels is approximately linear at a given growth stage. This method assumes that all leaves are at the same distance from the camera. This condition is fulfilled when using the orthorectified mosaic. Also, only leaves that are visible can be counted.

Plant leaves have similar morphology but different traits such as leaf length, width and green color hue. From the segmentation of each individual leaf, these traits can be estimated. In this section, we present a shape-based approach to leaf segmentation.

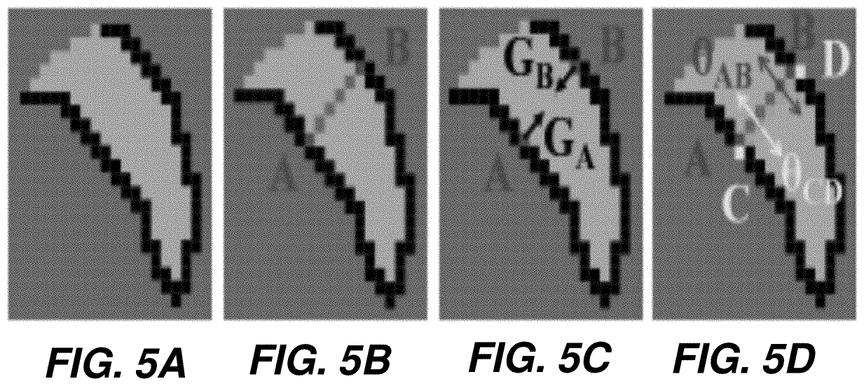

A and B are two pixels located at two opposite edges of a leaf. A pixel-wide line connecting A and B is defined as the leaf slice S_{AB}. FIG. 5 depicts these definitions with a synthetic leaf. The gradient angles at A and B are GA and

GB, respectively. The angle 0ϰ is defined in the direction of the x axis. GA and GB are expected to be opposite to each other with some bias Ta, i.e.,

|G_{A}−G_{B}+π|mod 2π<Tₐ (6)

Leaf slices are obtained by using the Stroke Width Transform. The slice angle θ_{AB} of S_{AB} is defined as the normal of the slice (in radians) as

$${θ}_{AB} = \frac{{G}_{A} + {G}_{B}}{2} mod π \qquad ( 7 )$$

In order to reconstruct leaves from leaf slices, adjacent leaf slices, SAB and SCD, are compared. If their angles θAB and ° C.D differ less than a constant Tb, i.e,

|θ_{AB}−θ_{BC}|<T_{b} (8)

then slices SAB and SCD are merged.

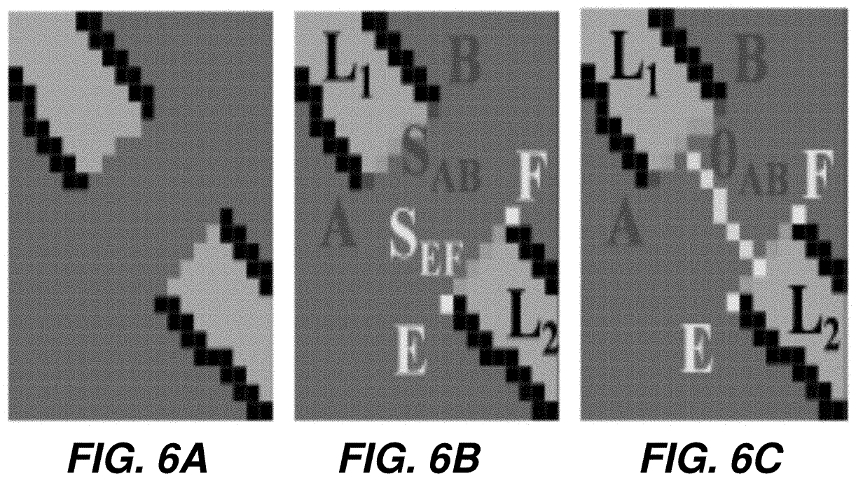

Plants with high leaf density can cause leaves overlap with each other. In the case of leaf overlap, there may be a dis-continuity between leaf slices as shown in FIG. 6.

In this case, the two leaf segments will be merged by the following search method. Let a leaf be split into two leaf segments L1 and L2, separated by a discontinuity, as shown in FIG. 6. Let SAB be the leaf slice with angle θAB at the end of L1. Let SEF be the leaf slice with angle θEF at the end of L2. Let XAB to be a vector contains all the pixels in SAB. From pixel xi in XAB, we search in the direction of θAB. If a leaf slice SEF from another leaf L2 is found and the difference between the two anglews is less than a constant Tc, i.e.,

|θ_{AB}−θ_{EF}|<T_{c}, (9)

Then leaves segments L1 and L2 are considered the same leaf.

Note that the thresholds Ta, Tb, Tc are determined experimentally. This method addresses leaf discontinuity due to leaf crossing, but requires that leaf edges are clearly distinguishable. Overlap of parallel leaves may lead to undersegmentation.

Next presented is a statistical model according to one embodiment for segmentation of the plant and determining its location. The location of each plant is defined as the pixel coordinates where the stalk intersects the ground plane and can be used to automatically obtain the inter-row and intra-row spacing. A row of plants is defined as all the plants that are aligned together. Inter-row spacing is defined as the distance between rows. Intra-row spacing is defined as the distance between plants within the same row.

The number of plants in an image is denoted as the constant P and assumed to be known a priori. The positions of the plants are modeled as a random vector X, i.e,

X=[X₀,X₁, . . . ,X_{P-1}] (10)

where Xp, p=0, . . . , P−1, contains the (i, j) coordinates of the p-th plant:

$${X}_{p} = [ \begin{matrix}{X}_{p , i} \\ {X}_{p , j}\end{matrix} ] \qquad ( 11 )$$

The goal is to estimate X from Y, where is Y is the color based segmentation mask. The 2D coordinates of the pixel m are denoted as K(m). A vector Z is constructed as

Z=[Z₀,Z₁, . . . ,Z_{N-1}] (12)

where each element Zn=K(n), n=0, . . . , N−1, is included if Yn=1. N is the number of pixels classified as leaf pixels. Notice that N<M.

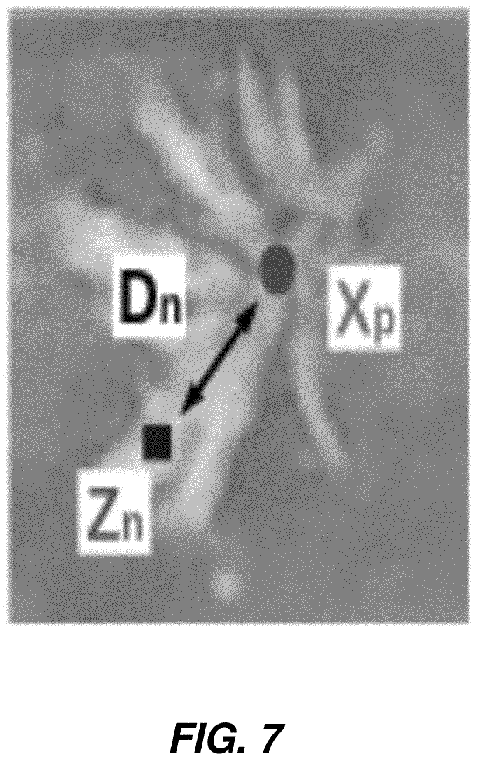

The plant p that is closest to the pixel n is denoted as C(n). The Euclidean distance from the pixel n to the plant C(n) is denoted as Dn and is computed as in Equation 13. FIG. 7 depicts the location Xp of one sorghum plant, and the distance Dn to a leaf pixel n.

$$\begin{matrix}{D}_{n} = {‖ K ( n ) - K ( C ( n ) ) ‖}_{2} \\ = {arg min}_{p = 0 , 1 , … , P - 1} {‖ K ( n ) - {X}_{p} ‖}_{2}\end{matrix} \qquad ( 13 )$$

Dn is modeled as a random variable with exponential conditional probability density with mean and standard deviation σ. Therefore the probability density function for a leaf pixel n at distance Dn=dn from C(n) is

$${p}_{{D}_{n}} ( {d}_{n} ) = \frac{1}{σ} {e}^{-} \text{?} \\ \text{?} \text{indicates text missing or illegible when filed} \qquad ( 14 )$$

o can be interpreted as the average radius of a plant.

Then, the conditional distribution of a single point Zn only depends on its closest plant:

$$\begin{matrix} {p}_{{Z}_{n} \vert X} ( {z}_{n} \vert X ) = {p}_{{Z}_{n} \vert {X}_{C ( n )}} ( {z}_{n} \vert {X}_{C} \text{?} ) \\ = \frac{1}{σ} {e}^{-} \text{?}\end{matrix} \\ \text{?} \text{indicates text missing or illegible when filed} \qquad ( 15 )$$

From our assumptions above we have conditional independence and the joint conditional density of Z is

$$\begin{matrix}{p}_{Z \vert X} ( z \vert X ) = {\prod }_{n = 1}^{N} {p}_{{Z}_{n} \vert X} ( {z}_{n} \vert X ) \\ = \frac{1}{{σ}^{N}} {e}^{- \frac{1}{σ} {\sum }_{n = 1}^{N} {d}_{n}}\end{matrix} \qquad ( 16 )$$

This model assumes that the leaf distribution does not have any direction preference, i.e. the leaves grow uniformly in all directions. In some situations, however, the plant is tilted, and the stalk is not completely at the center of the plant.

As seen in FIG. 4, since we are using an orthorectified mosaic, the crop field follows a structure. The plants in the image are very much aligned in rows as they are inb the field. We make use of this information to introduce a prior distribution for X.

The condition probability density of the position of one plant Xp given the remaining plants is assumed normal

$${p}_{{X}_{p} \vert {X}_{q \neq p}} ( {x}_{p} \vert {X}_{q \neq p} ) = \frac{1}{2 π {\vert {R}_{p} \vert}^{1 / 2}} exp ( - \frac{1}{2} {‖ {x}_{p} - {μ}_{p} ‖}_{{R}_{p}^{- 1}}^{2} ) \qquad ( 17 )$$

Where uₚ are the coordinates of the vertical and horizontal plant lines where Xp is a member, and

$${R}_{p} = [ \begin{matrix}{σ}_{p , i}^{2} & 0 \\ 0 & {σ}_{p , j}^{2}\end{matrix} ] \qquad ( 18 )$$

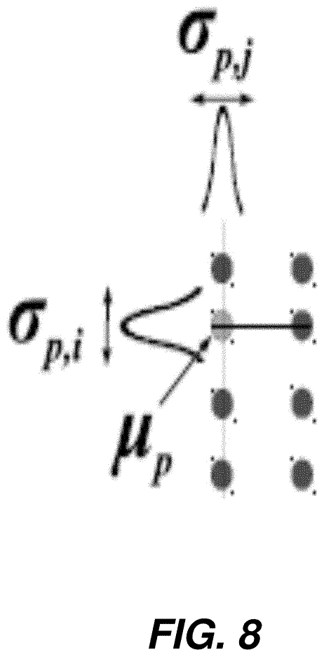

Is the covariance matrix of the positions of the plants that are aligned with the plant p, either vertically or horizontally. σ²_{p,i} and σ²_{p,j} are the vertical and horizontal standard deviations of Xₚ (see FIG. 8). σ²_{p,j} is typically very low because of the alignment of the planter at planting time. Rₚ is a diagonal matrix when the field rows are aligned with the image in the orthorectified image.

From Equation 16, we can obtain the MAP estimate of X as

$$\begin{matrix}\hat{X} ( Z ) = {arg max}_{x} {p}_{X \vert Z} ( x \vert Z ) = … \\ = {arg max}_{x} ( - ln {p}_{Z \vert X} ( Z \vert x ) - ln {p}_{X} ( x ) ) \\ = {arg max}_{x} ( \frac{1}{σ} {\sum }_{n = 1}^{N} {d}_{n} - ln {p}_{X} ( x ) )\end{matrix} \qquad ( 19 )$$

Obtaining a closed form for pX(x) involves dependencies between pant positions because the plant positions are not mutually independent. We iteratively obtain the MAP estimate of each plant position Xp separately:

$$\begin{matrix}{\hat{X}}_{p} ( Z ) = {arg max}_{{x}_{p}} {p}_{{X}_{p} \vert Z , {X}_{q \neq p}} ( x \vert Z , {X}_{q \neq p} ) = … \\ = {arg max}_{{x}_{p}} ( - ln {p}_{Z \vert X} ( Z \vert x ) - ln {p}_{{X}_{p} \vert {X}_{q \neq p}} ( {x}_{p} \vert {X}_{q \neq p} ) ) \\ = {arg max}_{{x}_{p}} ( \frac{1}{σ} {\sum }_{n = 1}^{N} {d}_{n} + \frac{1}{2} {‖ {x}_{p} - {μ}_{p} ‖}_{{R}_{p}^{- 1}}^{2} )\end{matrix} \qquad ( 20 )$$

For the special case in which the prior term is not used, the estimate X\hat{ }p(Z) in Equation 20 is reduced to

$${\hat{X}}_{p} ( Z ) = {arg min}_{{x}_{p}} {\sum }_{n = 1}^{N} {d}_{n} \qquad ( 21 )$$

This corresponds to the cost function of the k-means clustering technique. In this case, X\hat{ }p(Z), has a closed form solution, shown in Equation 21, which is the average of the points in the cluster fromed by plant p

$$\begin{matrix}{\hat{X}}_{p} ( Z ) = \frac{{\sum }_{n = 1}^{N} h ( {x}_{p} \vert {Z}_{n} ) {Z}_{n}}{{\sum }_{n = 1}^{N} h ( {x}_{p} \vert {Z}_{n} )} Where & ( 22 ) \\ h ( {x}_{p} \vert {Z}_{n} ) = \{ \begin{matrix}1 & if p = C ( n ) \\ 0 & otherwise\end{matrix} & ( 23 )\end{matrix}$$

is the membership function that indicates whether the pixel n corresponds to plant xp or not.

Another special case occurs when the prior distribution about the intra-row spacing prior is not used. When σ−>∞, Equation 20 becomes.

$${lim}_{{σ}_{p ,}} \text{?} {\hat{X}}_{p} ( Z ) = {arg min}_{{x}_{p}} ( \frac{1}{σ} {\sum }_{n = 1}^{N} {d}_{n} + \frac{1}{2} {( \frac{{x}_{p , j} - {μ}_{p , j}}{{σ}_{p , j}} )}^{2} ) \\ \text{?} \text{indicates text missing or illegible when filed} \qquad ( 24 )$$

Since σ is not known, we estimate it after every Iterative Coordinate Descent (ICD) iteration using the Maximum Likelihood estimator, that can be obtained in closed form:

$$\begin{matrix}\hat{σ} ( Z , X ) = {arg max {p}_{Z \vert X , σ}}_{σ} ( Z \vert X , σ ) = … \\ = \frac{1}{N} {\sum }_{n = 0}^{N - 1} {d}_{n}\end{matrix} \qquad ( 25 )$$

The methods and processes described above can be embodied in, and fully automated via, software code modules executed by one or more general purpose computers or processors. The code modules can be stored in any type of computer-readable storage medium or other computer storage medium. Some or all of the methods can alternatively be embodied in specialized computer hardware. For example, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

Those skilled in the art will recognize that numerous modifications can be made to the specific implementations described above. The implementations should not be limited to the particular limitations described. Other implementations may be possible.

1. A method of phenotyping plants in an agricultural field, comprising:
obtaining rectified orthophoto mosaic aerial images of plants in the field using a camera in an aerial vehicle; and
estimating the number of leaves of plants in the field by analyzing the morphology of the leaf segmentation using a computer processor.
